(19) United States
(12) Patent Application Publication
(10) Pub. No.: US 2025/0111761 A1
(43) Pub. Date: Apr. 3, 2025

(54) DUAL-TECHNOLOGY ELECTRONIC SEAL WITH INTEGRITY MONITORING SYSTEM AND INTEGRITY MONITORING METHOD OF SAID SEAL

(71) Applicant: MONITAINER TECNOLOGIA E SERVIÇOS LTDA, Santos (BR)

(72) Inventor: José Roberto França de Mesquita Filho, Sao Paulo (BR)

(21) Appl. No.: 18/750,163

(22) Filed: Jun. 21, 2024

(30) Foreign Application Priority Data
Oct. 2, 2023 (BR) BR1020230201814

(51) Int. Cl. G08B 13/12

(52) U.S. Cl. CPC G08B 13/12

(57) ABSTRACT

The present invention refers to a passive electronic seal with a unique digital identity for monitoring the integrity and authenticity of containers, doors, products, batches, records of liquid or powdery cargoes from trucks, chemical product nozzles, etc. It is a seal that comprises: a seal body comprising a substrate, a trim lock and internal circuit; said internal circuit comprising a passive and initially open capacitive element, the capacitive element having a unique digital identity; the electronic seal comprising a resistive locking element with one end fixedly connected to its body at an internal circuit terminal and a free end configured to pass through the trim lock and close it; closing said resistive element by additionally closing the internal capacitive circuit with an initial property in accordance with the resistivity of the resistive element. Furthermore, the present invention refers to a method for monitoring integrity using said seal based on two distinct forms of identification and monitoring, one being low proximity, using an NFC chip and the other being medium proximity, using RFID.

### PRIORITY CLAIM

This application claims priority to Brazilian Patent Application No. BR 10 2023 020181 4, filed Oct. 2, 2023, which is herein incorporated by reference in its entirety.

### FIELD OF INVENTION

The present invention belongs to the monitoring, location and logistics technological sector and refers to a passive electronic seal with a unique digital identity for monitoring the integrity and authenticity of containers, doors, products, lots, records of liquid or powdery bulk cargoes from trucks, chemical nozzles etc.

Furthermore, the present invention refers to a validation method using seals with a unique digital identity to validate the arrival and departure of containers, lots and products at different points in a chain of custody, as well as the state of integrity of the seal and of the sealed object.

### BACKGROUND OF THE INVENTION

The freight transport industry plays a key role in global trade, moving billions of tons of cargo every year. However, this massive logistics chain also presents significant challenges in terms of the safety and integrity of these circulated goods. In this context, seals that guarantee the integrity of transport units play a critical role. These small devices play a discrete but vital role in protecting goods throughout the transportation process, from the moment they are loaded into a container, vehicle or wrap until they are delivered to their destination.

The demand for secure, high-quality seals has grown substantially as national and international trade expands. With such a complex global supply chain, companies need to ensure their goods reach their destination exactly as they were sent. This not only prevents financial losses, but also reduces the risk of smuggling, theft and tampering with goods.

In this sense, some solutions and technologies have already been developed to solve these inconveniences.

Document US2010214077 describes a system that has a container-mounted bolt-type seal lock module that has the ability to store data and detect when the bolt is cut or certain environmental changes, such as impact, and a bolt-type seal lock that has data storage capacity, whereby the electronic module can be connected wirelessly to a centralized database for data exchange, and individual modules or seal locks can be networked together to transmit data to and from a stack of metal containers.

Document US2010013635 discloses an electronic locking device that secures a shipping container and includes a housing, two arms, a detection circuit and electronic components, wherein the pair of arms extends from the housing and couples to the bolt and transition of the arms between locked and unlocked configurations relative to the bolt, with one or both arms rotating relative to the other. Furthermore, the detection circuit is in a “closed” or “open” state, depending on whether the arms are in the locked or unlocked configuration and the electronics record and report the state of the detection circuit, thus indicating whether the arms are locked or not unlocked.

Furthermore, document EP2460150 describes a transport apparatus for small, high value or countable items comprising a substantially rigid housing comprising two opposing sections connected to each other, forming a container capable of being opened and closed, typically in a clamshell arrangement; an integral locking device for securing the container in the closed position; wherein the locking device includes: a microprocessor; a global positioning system (GPS) receiver; a power supply; and an electromechanical locking mechanism for actuating the locking device and for unlocking the locking device upon signal from the microprocessor when the shipping container has reached a selected geographic location.

As can be seen, the prior art solutions concern seals that require battery power to maintain constant communication with a central or terminal, in order to warn when or if there is a tampering. This type of solution, although efficient, limits the use of these technologies and makes seal production more expensive.

Another factor that must be taken into account to solve this problem is the lack of information coming from prior art seals, since these seals are capable of providing binary information regarding container tampering. This type of binary information is dangerous, considering that the methods and techniques for tampering with containers are increasingly sophisticated, making this type of seal subject to tampering by resealing the container, as well as subject to natural failures and/or failures caused in signal transmission in order to prevent monitors from being notified.

To solve these problems, the present invention provides an electronic seal with a passive circuit, which has a design that, in the event of tampering, is capable of reporting traces of tampering even if resealed, as well as a monitoring method that takes into account a qualitative and quantitative analysis of the seal to identify traces of tampering, in addition to distinguishing the location of the seal during the chain of custody made up of several agents, also ensuring that at each step of transport, the system can be updated in order to identify where and when a seal tampering occurred. Furthermore, a marked difference of the seal is its dual-technology of reading, allowing the use of radio frequency readings ranging from centimeters to meters, allowing the use of personal mobile devices and stationary antennas simultaneously.

Therefore, there is no solution in the state of the art equivalent to the one presented here in the present invention that combines technical differences, economic advantages, reliability and safety.

### OBJECTIVES OF THE INVENTION

Thus, the objective of the present invention is to provide a solution to the challenges and limitations listed above, presenting a seal with a monitoring and tamper indication system applied to various devices including, but not limited to, containers, lots, pallets, envelopes, among others.

It is a further objective of the present invention to provide a seal with a four-state integrity verification system, capable of informing and differentiating between an intact open seal, an intact closed seal, a tampered seal and/or a tampered resealed seal.

Another objective of the present invention is to provide a seal with a unique digital identifier that can be read by several different types of terminals from different agents along a chain of custody, such as small producers, large producers, port agents, cargo ship managers, etc.

Furthermore, the present invention also aims to provide a method that interprets seal data to determine whether the seal has been tampered with and resealed.

It is also an objective of the present invention to provide a method that allows monitoring the geolocation and condition of seals throughout a transport chain, ensuring that at each step of transport, the system can be updated with information regarding the integrity of the seal and its location.

It is also the objective of the present invention to provide a seal with simple design and low production cost and that can be easily incorporated into existing transport and production chains.

It is also the objective of the present invention to provide a reliable and safe seal and system for all agents in the production chain.

It is also an object of the present invention to provide a seal that is easily adaptable to any type of cargo, product or material.

### SUMMARY OF THE INVENTION

The present invention achieves these and other objectives through an electronic seal with a system for monitoring the integrity of an object, container or recipient comprising:
a seal body comprising a substrate, a locking lock and internal circuitry;
wherein said internal circuit comprises a passive and initially open capacitive/resistive circuit, the capacitive/resistive element of the internal circuit being at least one element of unique digital identity;
wherein said electronic seal comprises a resistive locking element with one end fixedly connected to the seal body at an internal circuit terminal and a free end configured to pass through the trim lock and close said internal circuit; wherein the operation of the electronic seal occurs by closing the resistive locking element in the trim lock so that closing said seals additionally closes the internal capacitive/resistive circuit with an initial property in accordance with their resistivity, which varies according to the point at which it was cut, material, thickness, among others.

Under another aspect of the present invention, a method of monitoring the integrity of an object, container or recipient comprising:
a first step of providing an electronic seal with a system for monitoring the integrity of an object, container or recipient;
a second step of closing the electronic seal, in which the rods that close the container door are tied, however, the resistive locking element can be used to tie gates, doors, lots, pallets and any object that is necessary to sealable tying, wherein the resistive locking element or others close the internal capacitive circuit with a unique property according to the resistivity of the resistive locking element or others, which varies according to the point at which it was cut, material, thickness, among others;
a third step of registration, in which the primary agent uses a digital interface to register the unique digital identity element on a digital platform and the unique digital identity element is read and the type of material within the lot is informed, container, pallet to be sealed by the electronic seal and linked to the unique digital identity element, correlating this data;
a fourth step of starting transport, the electronic seal is read through the unique digital identity element by a secondary agent and the electronic seal custody record is updated
a recurring step in which, with each new change of custody of sealed objects, the state of the electronic seal is diagnosed by the new secondary transport agent or by a tertiary agent at the final destination.

### BRIEF DESCRIPTION OF THE FIGURES

The present invention will be described based on the drawings attached here, which illustrate:

FIG. 1 represents a cross-sectional view of the sealing device of the present invention with the resistive locking element open in a preferred embodiment of cordage.

FIG. 2 represents a cross-sectional view of the sealing device of the present invention with the resistive locking element closed in a preferred embodiment of cordage.

FIG. 3 represents the schematic of the passive capacitive/resistive circuit of the seal when the device is sealed in a preferred embodiment of cordage.

### DETAILED DESCRIPTION OF THE INVENTION

The present invention relates to an electronic anti-tamper seal for monitoring the integrity and geolocation of containers, bales, lots, shipments, envelopes or products. The present invention uses an innovative construction through an electronic seal with a rigid body and a metallic or other resistive locking element which allow identifying whether the seal has been resealed after a tampering, preventing malicious third parties from tampering with the contents of the sealed object.

The seal of the present invention preferably uses different identification elements, allowing the seal to be read by different types of terminals from different agents along the transport chain, being a seal with dual-technology of reading with radio frequency, low and medium range.

It should be noted that, as already demonstrated, the state of the art does not offer a solution equivalent to the invention described here. This is because existing solutions are active and require power and communication to warn of any seal tampering, or are not capable of retaining information from four states of attempted tampering and/or tampering with resealing in a passive way, being a system with only two states in which it is only capable of providing interruption information from a closed circuit.

The present invention presents numerous technical and economic advantages when compared to the state of the art, some of which are listed below:
The present invention constitutes an electronic seal with a unique identifier that identifies, through records, the type of product and the agents under which the sealed object was in custody;
The present invention presents a system compatible with RF antenna terminals and proximal reading via NFC terminals, dual technology;
The present invention allows users to receive updates on the geolocation and status of seals with each update of the chain of custody.
The present invention has a very low production cost.

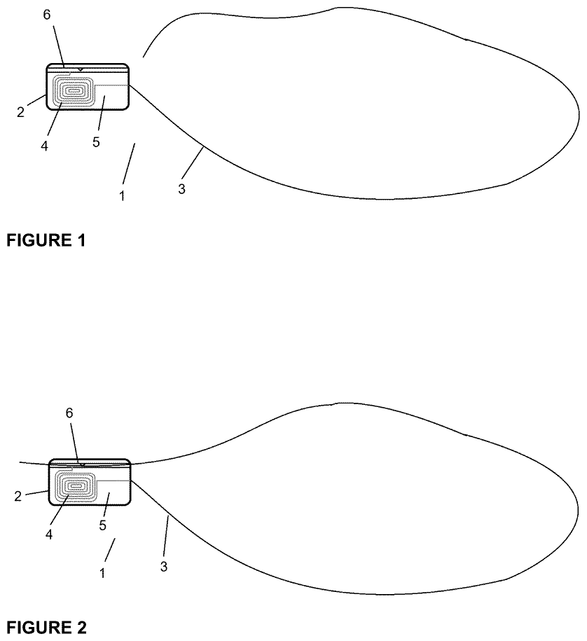

With reference to FIGS. 1 and 2, the electronic seal 01 object of the present invention comprises a seal body 02 comprising a unique digital identity element 04, a substrate 05, and a trim lock 06.

In a preferred embodiment of the present invention, the seal body 02 is made of injected plastic or metal and arranged around an internal circuit 07 in such a way that it is not possible to tamper or open the seal body 02 without destroying the internal circuit 07 or the substrate 05 and the seal body 02 itself.

The internal circuit 07 is preferably a passive and initially open capacitive circuit.

Furthermore, the electronic seal 01 comprises a resistive locking element 03 with one end fixedly connected to the seal body 02, at a terminal of the internal circuit 07 and a free end configured to pass through the trim lock 06 and close said internal circuit 07.

Additionally, the resistive locking element 03 is made of a metallic material with known resistivity.

Preferably, according to a first embodiment illustrated in FIGS. 1 to 3, the resistive locking element 03 is a cordage of malleable metal cable, which is 3.5 m long, and is configured to tie the rods that close the container door, however, the resistive locking element can be used for tying gates, doors, lots, pallets and any object that requires sealable tying.

In a preferred embodiment, the unique digital identity element 04 is a set of an NFC chip and an internal RF antenna, both comprising the capacitive elements of the internal circuit 07, on the substrate 05 within the seal body 02. However, embodiments are provided in which QR codes and/or barcodes are used.

As a result, the operation of the electronic seal 01 occurs through the closing the resistive locking element 03 in the trim lock 06. This closing in itself involves traditional mechanical interference of seals. The fact that the seal body 02 is injected makes it impossible for the seal body 02 to be opened, leaving only the option of breaking the resistive locking element 03 to open the container. A successful attempt to tamper the electronic seal 01 would leave the resistive locking element 03 visibly broken, indicating the tampering.

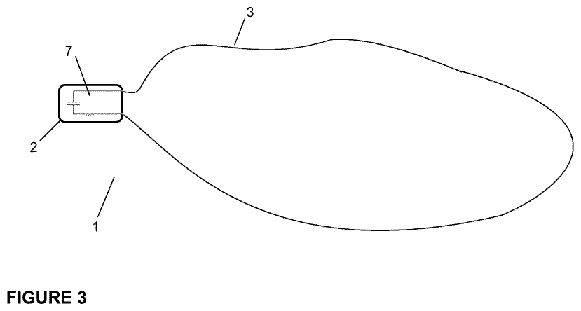

Furthermore, closing the resistive locking element 03 closes the internal capacitive circuit 07 with a unique property according to the resistivity of the resistive locking element 03, which varies according to the point at which it was cut, material, thickness, among others, as illustrated in FIG. 3.

The resistive locking element 03 is responsible for indicating the possibility of a successful tampering in which the violator changes the resistive locking element 03 or manages to perform a new seal with the remaining piece of the resistive locking element 03. In this case, the resistivity of the new resistive locking element 03 or the remaining portion of said resistive locking element 03 would not be the exact resistivity felt by the passive circuit at the time of original sealing and therefore the NFC or RF readings on a future point in the chain of custody would be different. Once this difference in reading has been identified, it is indicated that there was a tampering and a new resealing of the electronic seal 01 after the tampering, also indicating the possibility of tampering with the transported content.

As a result, it is a seal that enables an equally inventive method of validation and control of transport in steps with an analysis that provides complete information regarding the integrity of the seal.

### Step-by-Step Integrity Tracking and Control Method

The method comprises a sequence of closing steps, registration of the contents of the sealed object, beginning of transportation, as well as a recurring step of diagnosing the sealing condition at each change of custody.

In the first step of closing the electronic seal 01, the rods that close the container door are tied. However, the resistive locking element can be used for tying gates, doors, lots, pallets and any object that requires sealable tying, wherein the resistive locking element 03 closes the internal capacitive circuit 07 with a unique property according to the resistivity of the resistive locking element 03, which varies according to the point at which it was cut, material, thickness, among others.

In a second registration step, the primary agent uses a digital interface to register the unique digital identity element 04 on a digital platform. Furthermore, the NFC and RFID are preferably read and the type of material within the batch, container, pallet to be sealed by the electronic seal is informed 01. This information is linked to the unique digital identity element 04, correlating this data. Furthermore, the geolocation data of the digital interface terminal that registered the electronic seal 01 and the geolocation of the destination of the object sealed by the electronic seal 01 can be registered with the seal.

In a third step at the beginning of transport, the electronic seal 01 is read through the unique digital identity element 04 by a secondary agent and the custody record of electronic seal 01 is updated.

A recurring step in which, with each new change of custody of sealed objects, the state of the electronic seal 01 is diagnosed by the new secondary transport agent or by a tertiary agent at the final destination and the unique digital identity element 04 is read, whereby the geolocation and identity of the terminal that read the unique digital identity element 04 is recorded.

The diagnosis of the electronic seal 01 is carried out through the primary and qualitative analysis of the state of the resistive locking element 03, so that if the resistive locking element 03 is broken or the seal body 02 is shattered, and the system is informed that the electronic seal 01 is in a broken, non-intact state and if both the resistive locking element 03 and the seal body 02 are intact, the system is informed that the electronic seal 01 is in a sealed state.

After the qualitative analysis, a reading of the unique digital identity element 04 is carried out, in order to verify the variation in the reading of said unique digital identity element 04, caused by a possible exchange of the resistive locking element 03 or carrying out a new seal with the remaining piece of the resistive locking element 03 through the difference in resistivity of the resistive locking element 03 initial at the time of sealing and the current resistive locking element 03, so that if the reading difference of the unique digital identity element 04 is detected, the system determines that the electronic seal 01 is in an non-intact sealed state and if the reading difference of the unique digital identity element 04 is not detected, the system is informed that the electronic seal 01 is in an intact sealed state.

This way, even if there are several agents in the transport process, it is possible to identify the point at which the electronic seal 01 breaks or the resistive locking element 03 is tampered with. Mainly for transport involving containers, it is important to know if there is a attempt to reseal, since in addition to cargo theft, there is the danger of placing illicit cargo in the container for trafficking.

As a result, the method provides extremely efficient, safe, automatable and decentralized monitoring, being a low-cost device that is easy to implement in existing processes and chains, but increasing the degree of security and reliability.

Having described examples of preferred embodiments of the present invention, it must be understood that the scope of the present invention covers other possible variations of the described inventive concept, being limited only by the content of the claims alone, including possible equivalents.

We claim:

1. An electronic seal (1) with system for monitoring the integrity of an object, recipient or container, the seal comprising a seal body (2) comprising a substrate (5), a trim lock (6) and internal circuit (7),
wherein said internal circuit (7) comprises a passive and initially open capacitive/resistive circuit, the capacitive/resistive element of the internal circuit (7) being at least one unique digital identity element (4);
wherein said electronic seal (1) comprises a resistive locking element (3) with one end fixedly connected to the seal body (2), at a terminal of the internal circuit (7) and a free end configured to pass through the trim lock (6) and close said internal circuit (7); and
wherein the operation of the electronic seal (1) takes place by closing the resistive locking element (3) in the trim lock (6) so that the closing of said resistive locking element (3) additionally closes the internal circuit (7) capacitive with an initial property according to the resistivity of the resistive locking element (3), which varies according to the point at which it was cut, the material, and the thickness.

2. The electronic seal according to claim 1, wherein the seal body (2) is made of injected plastic or metal and arranged around the substrate (5) and the internal circuit (7).

3. The electronic seal according to claim 1, wherein said resistive locking element (3) is a malleable cordage.

4. The electronic seal according to claim 3, wherein said resistive locking element (3) is made of a metallic material and with predetermined resistivity.

5. The electronic seal according to claim 1, wherein the unique digital identity element (4) is a set of an NFC chip, an RFID and an internal antenna RF, both forming the capacitive elements of the circuit internal (7), on the substrate (5) inside the seal body (2).

6. The electronic seal according to claim 1, wherein the resistive locking element (3) is between 2.5 m and 4.5 m in length, and is configured to tie the rods that close the container door.

7. A method of monitoring the integrity of an object, recipient or container, the method comprising:
(a) providing an electronic seal (1) with an integrity monitoring system for an object, recipient or container comprising a seal body (2) comprising a substrate (5), a trim lock (6) and internal circuit (7);
wherein said internal circuit (7) comprises a passive and initially open capacitive circuit, the capacitive element of the internal circuit (7) being at least one unique digital identity element (4);
wherein said electronic seal (1) comprises a resistive locking element (3) with one end fixedly connected to the seal body (2) at a terminal of the internal circuit (7) and a free end configured to pass through the trim lock (6) and close said internal circuit (7); and
wherein the operation of the electronic seal (1) occurs by closing the resistive locking element (3) in the internal circuit (7) so that the closing said resistive locking element (3) closes the internal capacitive circuit (7) with an initial property in accordance with the resistivity of the resistive locking element (3), which varies according to the point at which it was cut, the material, and the thickness;
(b) closing the electronic seal (1), in which the rods that close the container door are tied, but the resistive locking element can be used to tie gates, doors, lots, pallets,
wherein the resistive locking element (3) closes the internal capacitive circuit (7) with a unique property according to the resistivity of the resistive locking element (3), which varies according to the point at which it was cut, the material, and the thickness;
(c) registering the electronic seal, in which the primary agent uses a digital interface to register the unique digital identity element (4) on a digital platform and the unique digital identity element (4) and the identity of the unique digital identity element (4) is linked to the type of material within the batch, container, pallet to be sealed by the electronic seal (1); and
(d) transporting the electronic seal, in which the electronic seal (1) is read through the unique digital identity element (4) by a secondary agent and the electronic seal custody record (1) is updated.

8. The method of claim 7, further comprising, after the transporting step, a recurring step in which, with each new change of custody of sealed objects, the status of the electronic seal (1) is diagnosed by the new secondary transport agent or by a tertiary agent at the final destination and the unique digital identity element is read (4), wherein the geolocation and identity of the terminal that read the unique digital identity element (4) are recorded.

9. The method, according to claim 8, wherein said diagnosis of the state of the electronic seal (1) of the recurring step comprises:
a first qualitative analysis of the state of the resistive locking element (3), in which it is analyzed to determine (a) if the resistive locking element (3) is broken or the seal body (2) is shattered, whereby the system is informed that the electronic seal (1) is in an non-intact tampered state; or (b) if both the resistive locking element (3) and the seal body (2) are intact, whereby the system is informed that the electronic seal (1) is in a sealed state; and
a second quantitative analysis in which a reading of the unique digital identity element (4) is carried out, so as to verify the variation in the reading of said unique digital identity element (4), caused by a possible change of the resistive locking element (3) or to perform a new seal with the remaining piece of the resistive locking element (3) through the difference in resistivity of the initial resistive locking element (3) at the time of sealing and the current resistive locking element (3), so that (a) if the reading difference of the unique digital identity element (4) is detected, the system determines that the electronic seal (1) is in an non-intact sealed state, and (b) if the reading difference of the unique digital identity element (4) is not detected, the system is informed that the electronic seal (1) is in an intact sealed state.

10. The method according to claim 7, wherein the unique digital identity element (4) is a set of an NFC chip, an RFID, or an internal antenna RF; and the reading of said unique digital identity element (4) is done by an NFC and/or RFID reading terminal.

11. The method according to claim 7, wherein, during the registering step, the geolocation data of the digital interface terminal that registered the electronic seal (1) and the geolocation of the destination of the object sealed by the electronic seal (1) is recorded next to the seal.

12. The method according to claim 7, wherein said resistive locking element (3) is a cordage having a length between 0.30 m and 7.5 m, and is configured to tie the rods that close the container door, gates, doors, lots, and pallets.

13. The method, according to claim 12, wherein said resistive locking element (3) is made of a metallic material and with predetermined resistivity.
